(19) United States
(12) Patent Application Publication
(10) Pub. No.: US 2010/0152972 A1
(43) Pub. Date: Jun. 17, 2010

(54) PARALLEL PARK ASSIST

(76) Inventors: Joe Charles Attard, Dearborn, MI (US); Jeffrey Allen Bochenek, Milford, MI (US); Stanley Lawrence Seely, Canton, MI (US)

Correspondence Address: FRASER CLEMENS MARTIN & MILLER LLC, 28366 KENSINGTON LANE, PERRYSBURG, OH, 43551, US

(21) Appl. No.: 12/334,920

(22) Filed: Dec. 15, 2008

(51) Int. Cl. B62D 6/00; G01S 3/02

(52) U.S. Cl. 701/42; 701/44; 342/457

(57) ABSTRACT

A parallel parking assist system and a method for evaluating an area for use as a parking space for a host vehicle, the parallel park assist system comprises a ultra wideband radar sensor disposed in the host vehicle, wherein the radar sensor obtains a measurement data relating to a potential parking space and transmits a data signal representing the measurement data, a processor adapted to receive the transmitted data signal from the sensor, analyze the data signal, and transmit an alert signal in response to the analysis of the data signal, and a user interface adapted to receive the alert signal and provide an alert to the driver of the host vehicle in response to the alert signal, wherein the alert signal represents the suitability of the potential parking space.

### FIELD OF THE INVENTION

The invention relates to vehicle systems. More particularly, the invention is directed to a parallel parking system and method for evaluating an area for use as a parking space for a host vehicle.

### BACKGROUND OF THE INVENTION

Vehicle systems are being developed for vehicles, wherein the systems are intended to make a driver more aware of the surroundings. Currently the systems are for both the front (Adaptive Cruise Control and Lane Departure warning) and rear of the vehicle (Rear Park Assist and Blind Spot/Lane Change Aide).

The current vehicle systems and features are being realized using a host of different technologies. Adaptive Cruise Control typically uses millimeter wave radar and laser radar, while Lane Departure Warning uses cameras. Rear Park Assist typically uses ultrasonic sensor and cameras, while Blind Spot detection uses millimeter wave radar. All of the systems and features attempt to increase the driver's awareness of other vehicles and objects that are in close proximity to the host vehicle, thus allowing the driver to make a more informed decision, and in some cases, avoid an accident.

However, none of the current systems help a driver when attempting a parallel parking maneuver. Parallel parking is often a very stressful maneuver for the driver for many reasons. For example, parallel parking is typically done on a busy secondary street and the maneuver is not necessarily executed regularly. One of the first pieces of information the driver needs when contemplating the parallel parking maneuver is whether the host vehicle will fit into the open or potential parking space. Often times this can be a very difficult judgment to make in a timely manner with only a visual glance.

It would be desirable to have a parallel park assist system and a method for evaluating an area for use as a parking space for a host vehicle, wherein the system and method provide an alert to the driver representing the suitability of a potential parking space, while minimizing a required number of sensors.

### SUMMARY OF THE INVENTION

Concordant and consistent with the present invention, a parallel park assist system and a method for evaluating an area for use as a parking space for a host vehicle, wherein the system and method provide an alert to the driver representing the suitability of a potential parking space, while minimizing a required number of sensors, has surprisingly been discovered.

In one embodiment, a parallel park assist system for a host vehicle comprises: a ultra wide band radar sensor disposed in the host vehicle, wherein the radar sensor obtains a measurement data relating to a potential parking space and transmits a data signal representing the measurement data; a processor adapted to receive the transmitted data signal from the sensor, analyze the data signal, and transmit an alert signal in response to the analysis of the data signal; and a user interface adapted to receive the alert signal and provide an alert to the driver of the host vehicle in response to the alert signal, wherein the alert signal represents the suitability of the potential parking space.

The invention also provides methods for evaluating an area for use as a parking space for a host vehicle.

One method comprises the steps of: providing a sensor disposed in the host vehicle, wherein the sensor obtains a measurement data and transmits a data signal representing a measurement data; providing a processor disposed in the host vehicle and adapted to receive the transmitted data signal from the sensor, analyze the data signal, and transmit an alert signal in response to the analysis of the data signal; positioning the host vehicle adjacent a first parked car, wherein the sensor obtains the measurement data between the host vehicle and the first parked car; maneuvering the host vehicle past a potential parking space below a predetermined speed, wherein the sensor continues to obtain the measurement data; evaluating the measurement data received by the sensor; and transmitting the alert signal to a driver in response to the evaluation of the measurement data, wherein the alert signal represents the suitability of the potential parking space.

Another method comprises the steps of providing a sensor disposed in the host vehicle, wherein the sensor obtains a measurement data and transmits a data signal representing the measurement data providing a processor adapted to receive the transmitted data signal from the sensor, analyze the data signal, and transmit an alert signal in response to the analysis of the data signal, positioning the host vehicle in a pre-determined position relative to a potential parking space, wherein the sensor obtains the measurement data between the host vehicle and at least one parked vehicle; receiving the data signal from the sensor, wherein the data signal represents a location of the at least one parked vehicle relative to the host vehicle; evaluating the data signal; and transmitting the alert signal to a driver in response to the evaluation of the data signal, wherein the alert signal represents the suitability of the potential parking space.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a side elevational view of a host vehicle including a parallel park assist system shown in schematic, according to an embodiment of the present invention;

FIG. 2 is a schematic block diagram of the parallel park assist system of FIG. 1;

FIG. 3 is a schematic diagram of the host vehicle of FIG. 1, shown in a parallel parking environment;

FIG. 4 is a flow chart of a method for evaluating an area for use as a parking space for a host vehicle, according to an embodiment of the present invention;

FIG. 5 is a schematic diagram of the host vehicle of FIG. 1, shown executing an initiation step of the method of FIG. 4;

FIG. 6 is a schematic diagram of the host vehicle of FIG. 1, shown executing a measurement step of the method of FIG. 4;

FIG. 7 is a schematic diagram of the host vehicle of FIG. 1, shown executing an evaluation step of the method of FIG. 4;

FIG. 8 is a schematic diagram of the host vehicle of FIG. 1, shown executing another method for evaluating an area for use as a parking space for a host vehicle, according to an embodiment of the present invention; and

FIG. 9 is a flow chart of the method of FIG. 8.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

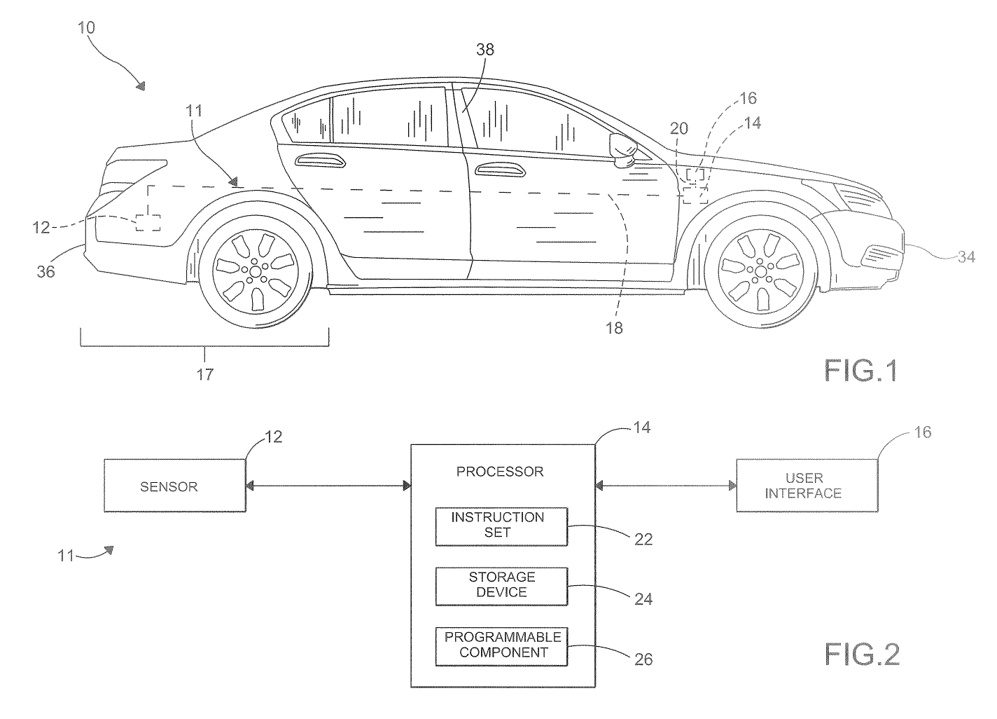

Referring to FIGS. 1 and 2, a host vehicle 10 is shown including a parallel park assist (PPA) system 11 according to an embodiment of the present invention. In the embodiment shown, the PPA system 11 includes a sensor 12, a processor 14, and a user interface 16. It is understood that any number of sensors 12, processors 14, and user interfaces 16 may be used, as desired. It is further understood that additional components, systems, and devices may be include and adapted to interact with the sensor 12, the processor 14, and the user interface 16, as desired.

The sensor 12 illustrated is an ultra wideband (UWB) radar sensor having a pre-determined resolution and adapted to measure a location of other objects relative to the host vehicle 10. Other devices and sensors, now known or later developed, may be used to measure the location of other objects relative to the host vehicle 10, as appropriate. The sensor 12 is shown disposed in a rear portion 17 of the vehicle. However, it is understood that the sensor 12 may be disposed in any position and orientation as desired. In certain embodiments, one sensor 12 is disposed on a passenger side of the host vehicle 10 and one sensor 12 is disposed on a driver side of the host vehicle 10. However, it is understood that any number of sensors 12 may be used, as desired. The sensor 12 is in communication with the processor 14, wherein the sensor 12 transmits a data signal 18 to the processor 14. In certain embodiments, the data signal 18 includes information related to azimuth angle and distance range relative to the sensor 12. Other information and data may be included in the data signal 18, as desired. It is understood that the means for communication between the sensor 12 and the processor 14 may be any form of communication. For example, the means for communication may be wireless, Ethernet, vehicle network, serial bus, and the like. Other means of communication may be used, as desired. In certain embodiments, the sensor 12 and the processor 14 integrated in a single module.

The processor 14 may be any device or system adapted to receive the data signal 18 transmitted from the sensor 12, analyze and evaluate the data signal 18, and transmit an alert signal 20 to the user interface 16 in response to the analysis and evaluation of the data signal 18. In certain embodiments, the processor 14 is a micro-computer. It is understood that the processor 14 may be in communication with and may provide control of other devices, systems and components.

As shown, the processor 14 analyzes and evaluates the data signal 18 based upon an instruction set 22. The instruction set 22, which may be embodied within any computer readable medium, includes processor executable instructions for configuring the processor 14 to perform a variety of tasks. It is understood that the processor 14 may execute a variety functions such as controlling the functions of the sensor 12 and user interface 16, for example. It is further understood that the sensor 12 and the processor 14 may be integrated in a single module.

In certain embodiments, the processor 14 includes a storage device 24. The storage device 24 may be a single storage device or may be multiple storage devices. Furthermore, the storage device 24 may be a solid state storage system, a magnetic storage system, an optical storage system or any other suitable storage system or device. It is understood that the storage device 24 is adapted to store the instruction set 22. Other data and information may be stored in the storage device 24, as desired.

The processor 14 may further include a programmable component 26. It is understood that the programmable component 26 may be in communication with any other component of the PPA system 11 such as the sensor 12 and the user interface 16, for example. In certain embodiments, the programmable component 26 is adapted to manage and control processing functions of the processor 14. Specifically, the programmable component 26 is adapted to control the analysis of the data signal 18 and the transmission of the alert signal 20. It is understood that the programmable component 26 may be adapted to manage and control the sensor 12 and the user interface 16. It is further understood that the programmable component 26 may be adapted to store data and information on the storage device 24, and retrieve data and information from the storage device 24.

The user interface 16 is a device or system adapted to receive the alert signal 20 and transmit an alert or warning to the driver of the host vehicle 10, wherein the driver alert represents a “GO”, advising the driver to attempt a parallel park maneuver, or a “NO”, advising the driver not to attempt a parallel park maneuver for a particular space. For example, the user interface 16 may be a liquid crystal display, wherein the driver alert is in text form. As another example, the user interface 16 may be a light system, wherein the “GO” driver alert is represented by a particular color (e.g. green) and the “NO” driver alert is represented by a second color (e.g. red). However, it is understood that any other user interface 16 such as an audio system and a touch screen display may be used, as desired. It is further understood that any driver alert may be used to alert, warn, or advise the driver of the host vehicle 10.

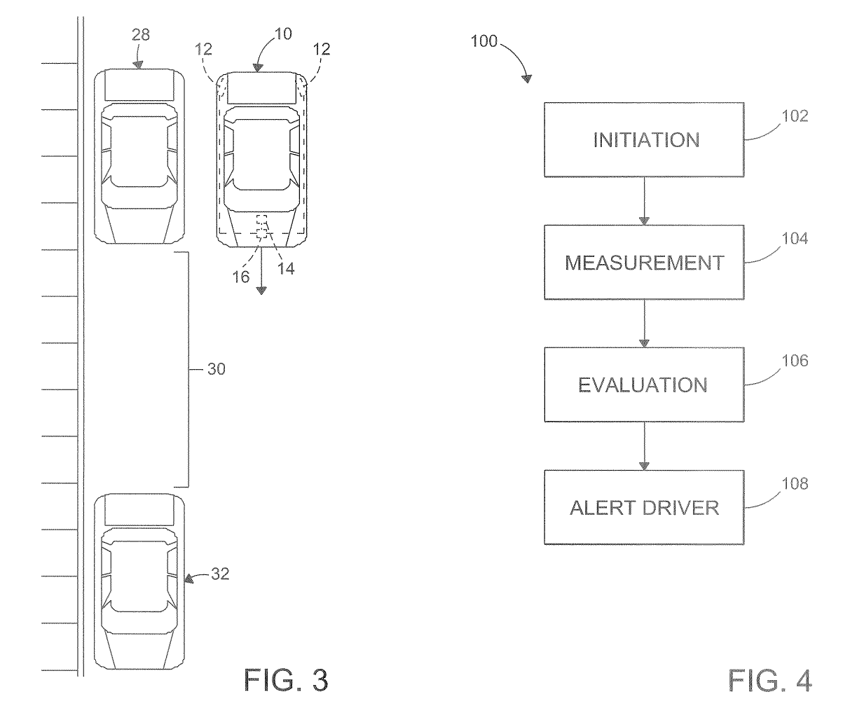

FIG. 3 shows the host vehicle 10 positioned adjacent a first parked vehicle 28. As shown, a potential parking space 30 is defined as an area between the first parked vehicle 28 and a second parked vehicle 32. It is understood that the first parked vehicle 28 and the second parked vehicle 32 may have any alignment relative to each other and the host vehicle 10.

FIGS. 4-7 illustrate a method 100 for evaluating an area for use as a parking space for the host vehicle 10 according to the present invention. FIG. 4 shows the method 100 including an initiation step 102, a measurement step 104, an evaluation step 106, and a alert driver step 108.

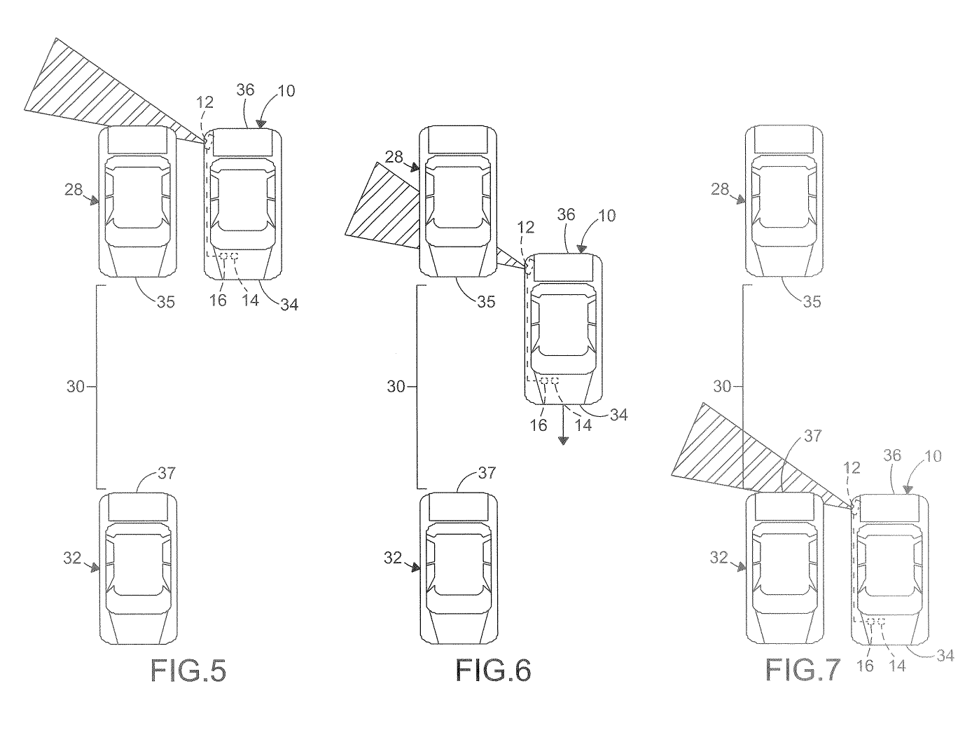

FIG. 5 more clearly illustrates the initiation step 102, wherein the driver positions the host vehicle 10 alongside the first parked vehicle 28. As a non-limiting example, the host vehicle 10 is positioned relative to the first parked vehicle 28 such that a front bumper 34 of the host vehicle 10 is approximately aligned with a front bumper 35 of the first parked vehicle 28. It is understood that a distance between the host vehicle 10 and the first parked vehicle 28 may be a standard distance for a parallel park maneuver (0.5 m-2.5 m). However, the sensor 12 may be adjusted to measure any relative distance ranges and angles, as desired. During the initiation step 102, the processor 14 receives the data signal 18 from the sensor 12, processes the received data signal 18, and determines the motion of the first parked vehicle 28. Where the first parked vehicle 28 is determined to be stationary, the method 100 continues to the measurement step 104. In certain embodiments, the distance range from the host vehicle 10 to the first parked vehicle 28 is stored for later reference by the processor 14. It is understood that a distance range to a stationary object may be used to determine the presence of an “open” or potential parking space 30. For example, the “open” parking space may be determined from a change in the distance range at a particular angle of measurement. Other methods for determining the existence of an “open” parking space may be used, as desired.

FIG. 6 illustrates the measurement step 104, wherein the host vehicle 10 is maneuvered past the potential parking space 30 at a speed which is below a predetermined speed threshold. In certain embodiments, the speed of the host vehicle 10 during the measurement step 104 is less than 15 miles per hour. However, it is understood that the measurement speed of the host vehicle 10 may be programmed to be any speed, as desired. As the host vehicle 10 moves past the potential parking space 30, the processor 14 continuously receives measurement data from the sensor 12. It is understood that processor 14 may be adapted to retrieve the data signal 18, including measurement data, at periodic times or continuously. Where is the host vehicle 10 is equipped with additional sensors 12, the processor 14 analyzes the data signal 18 receives from each of the sensors 12 to determine the location of the potential parking space 30 relative to the host vehicle 10. In certain embodiments, the sensor 12 provides very accurate distance range and azimuth angle measurement data, wherein the measurement data is later evaluated by the processor 14 to calculate the distance to and location of each of the parked vehicles 28, 32 defining the potential parking space 30. Additionally, a distance traveled calculation, based upon the linear distance traveled by the host vehicle 10 during the measurement step 104, is initiated when the processor 14 detects a transition of distance range within a pre-determined field of view of the sensor 12. As a non-limiting example, the distance traveled calculation is accomplished by counting wheel rotations and applying known calculations based upon the dimensions of the wheel and the speed of the host vehicle 10. The distance traveled calculation is stopped when the processor 14 detects a second transition of distance range (i.e. detection of the second parked vehicle 32). As a non-limiting example, the start and stop location of the distance travelled calculation is based on the distance range and azimuth data within a small degree (±3 deg) of the field of view of the sensor 12. In certain embodiments, the distance traveled calculation is initiated when a pre-determined distance range and azimuth angle are measured within a small degree (±3 deg) of the field of view of the sensor 12. Likewise, the distance travelled calculation is ended when the distance range and azimuth data are within the same small degree (±3 deg) of the field of view of the sensor 12. It is understood that the field of view of the sensor 12 may be one beam of a multi beam system or a smaller portion of a larger beam.

FIG. 7 illustrates the evaluation step 106, wherein the host vehicle 10 is stopped at a pre-determined position relative to the second parked vehicle 32. For example, the host vehicle 10 is positioned such that the rear bumper 36 of the host vehicle 10 is approximately aligned with the rear bumper 37 of the second parked vehicle 32. Once the host vehicle 10 is stopped, the processor 14 evaluates the received measurement data of the data signal 18, including distance travelled calculation, to determine the distance between the first parked vehicle 28 and the second parked vehicle 32 and thereby, the dimensions of the potential parking space 30. It is understood that the processor 14 may evaluate the received measurement data when the host vehicle 10 is moving. It is further understood that the evaluation of the received measurement data may be initiated at anytime. The calculated dimensions of the potential parking space 30 are multiplied by a pre-determined factor to allow for parking maneuverability. Although a default maneuverability factor may be set at 1.7, it is understood that any factor may be used. It is further understood that the evaluation executed by the processor 14 may be adapted to account for additional known or pre-determined variables such as the dimensions of the host vehicle 10 and the skill level of a current driver of the host vehicle 10, for example. Once the maneuverability factor is applied to the dimensions of the potential parking space 30, the processor 14 compares the factored dimensions of the potential parking space 30 to a pre-determined host value. It is understood that the pre-determined host value may be pre-programmed as a default value based upon the dimensions of the host vehicle 10. Other means for determining the default host value may be used, as desired.

In the alert driver step 108, the processor 14 generates the GO/NO alert signal 20 to the user interface 16 in response to the evaluation of the data signal 18. Specifically, where the factored dimensions of the potential parking space 30 exceed the limitations of the host value, the alert signal 20 represents a “GO” driver alert. Conversely, where the factored dimensions of the potential parking space 30 do not exceed the limitations of the host value, the alert signal represents a “NO” driver alert. Other means for determining the GO/NO status of the alert signal 20 may be used, as desired. In certain embodiments, the processor 14 evaluates the data signal 20 to determine a suitable position of the host vehicle 10 relative to the parked vehicles 28, 32 for initiating a parallel parking maneuver. Additionally, the user interface 16 may indicate to the driver when the host vehicle 10 is in a suitable position for initialing the parallel parking maneuver.

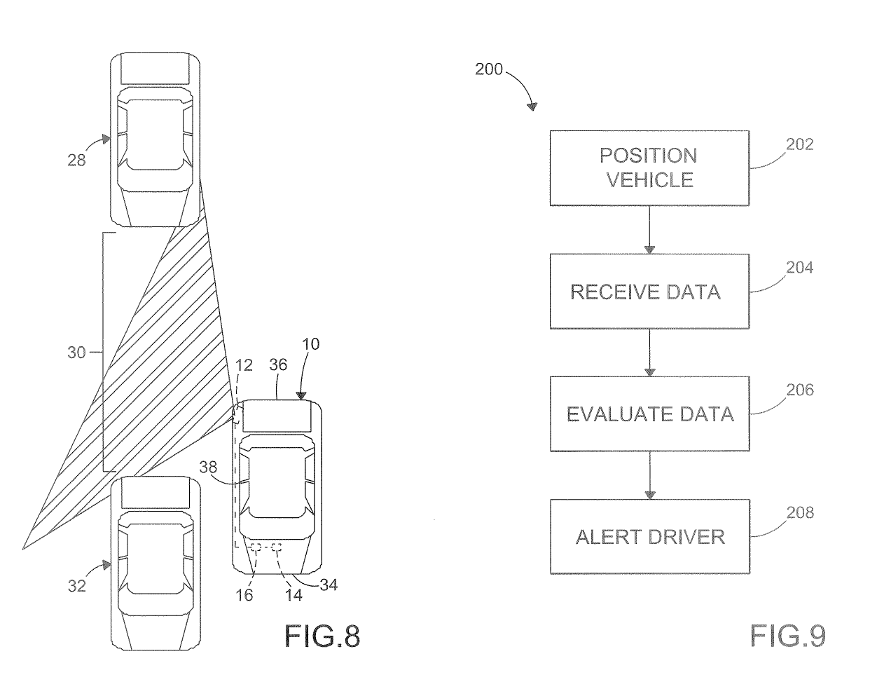

FIGS. 8 and 9 illustrate another method 200 for evaluating an area for use as a parking space for the host vehicle 10 according to the present invention. In step 202, the host vehicle 10 is stopped in a pre-determined position relative to the second parked vehicle 32, wherein the sensor 12 is able to measure a distance range and angle between the host vehicle 10 and the first parked vehicle 28 and between the host vehicle 10 and the second parked vehicle 32. As more clearly shown in FIG. 8, the pre-determined position of the host vehicle 10 may be at a point where a “B” pillar 38 of the host vehicle 10 is approximately aligned with the rear bumper 37 of the second parked vehicle 32. In step 204, the sensor 12, having a pre-determined field of view, measures the distance range and angle between the host vehicle 10 and each of the parked vehicles 28, 32, from the pre-determined position of step 202, and transmits the data signal 18 including the distance range and angle measurement data. As such, the processor 14 receives the data signal 18 from the sensor 12. In step 206, the processor 14 analyzes the measurement data included in the data signal 18 to determine a location of the first parked vehicle 28 and a location of the second parked vehicle 32. Using mathematical and algorithmic techniques such as trigonometry, the processor 14 calculates the distance from the rear bumper 37 of the second parked vehicle 32 to the front bumper 35 of the first parked vehicle 28 and thereby, the dimensions of the potential parking space 30. The calculated dimensions of the potential parking space 30 are multiplied by a pre-determined factor to allow for parking maneuverability. Although a default maneuverability factor may be set at 1.7, it is understood that any factor may be used. It is further understood that the evaluation executed by the processor 14 may be adapted to account for additional known or pre-determined variables such as the dimensions of the host vehicle 10 and the skill level of a current driver of the host vehicle 10, for example. Once the maneuverability factor is applied to the dimensions of the potential parking space 30, the processor 14 compares the factored dimensions of the potential parking space 30 to a pre-determined host value. It is understood that the pre-determined host value may be pre-programmed as a default value based upon the dimension of the host vehicle 10. Other means for determining the default host value may be used, as desired.

In the alert driver step 208, the processor 14 generates the GO/NO alert signal 20 to the user interface 16 in response to the evaluation of the data signal 18. Where the factored dimensions of the potential parking space 30 exceed the limitations of the host value, the alert signal 20 represents a “GO” driver alert. Conversely, where the factored dimensions of the potential parking space 30 do not exceed the limitations of the host value, the alert signal represents a “NO” driver alert. Other means for determining the GO/NO status of the alert signal 20 may be used, as desired. In certain embodiments, the processor 14 evaluates the data signal 20 to determine a suitable position of the host vehicle 10 relative to the parked vehicles 28, 32 for initiating a parallel parking maneuver. Additionally, the user interface 16 may indicate to the driver when the host vehicle 10 is in a suitable position for initialing the parallel parking maneuver.

The PPA system 11 and methods 100, 200 for evaluating an area for use as a parking space for the host vehicle 10 provide a means for alerting and advising the driver of the host vehicle 10 of the suitability of the potential parking space 30, while minimizing the required number of sensor devices. The PPA system 11 and methods 100, 200 assist the driver by determining whether the host vehicle 10 will fit into the open or potential parking space 30, thereby minimizing the need for judgment decision by the driver. Additionally, the PPA system 11 and methods 100, 200 assist the driver by determining a suitable position of the host vehicle 10 relative to the parked vehicles 28, 32, for initiating the parallel parking maneuver.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A method for evaluating an area for use as a parking space for a host vehicle, the method comprising the steps of:
providing a sensor disposed in the host vehicle, wherein the sensor obtains a measurement data and transmits a data signal representing the measurement data;
providing a processor disposed in the host vehicle adapted to receive the transmitted data signal from the sensor, analyze the data signal, and transmit an alert signal in response to the analysis of the data signal;
positioning the host vehicle adjacent a first parked car, wherein the sensor obtains the measurement data between the host vehicle and the first parked car;
maneuvering the host vehicle past a potential parking space at a speed below a predetermined speed threshold, wherein the sensor continues to obtain the measurement data;
evaluating the measurement data received by the sensor; and
transmitting the alert signal to a driver in response to the evaluation of the measurement data, wherein the alert signal represents the suitability of the potential parking space.

2. The method according to claim 1, wherein the measurement data includes a distance range and an angle between the host vehicle and other objects.

3. The method according to claim 1, wherein the sensor is an ultra wideband radar sensor with a predetermined resolution.

4. The method according to claim 1, wherein the sensor is disposed in a rear portion of the host vehicle.

5. The method according to claim 1, further comprising the step of providing a user interface in communication with the processor, wherein the user interface receives the alert signal and transmits a driver alert in response to the alert signal.

6. The method according to claim 1, wherein the processor includes at least one of a programmable component adapted to provide user-controlled management of at least one of the sensor and the processor and a storage device for storing information and data.

7. The method according to claim 1, further comprising the step of calculating a value for a distance traveled based upon the linear distance traveled by the host vehicle while maneuvering past the potential parking space.

8. The method according to claim 1, wherein the evaluation of the measurement data includes at least one of calculating the dimensions of the potential parking space, applying a maneuverability factor to the calculated dimensions of the potential parking space, and determining a suitable position of the host vehicle for initiating a parallel parking maneuver.

9. A method for evaluating an area for use as a parking space for a host vehicle, the method comprising the steps of:
providing a sensor disposed in the host vehicle, wherein the sensor obtains a measurement data and transmits a data signal representing the measurement data;
providing a processor adapted to receive the transmitted data signal from the sensor analyze the data signal and transmit an alert signal in response to the analysis of the data signal;
positioning the host vehicle in a pre-determined position relative to a potential parking space, wherein the sensor obtains the measurement data between the host vehicle and at least one parked vehicle;
receiving the data signal from the sensor, wherein the data signal represents a location of the at least one parked vehicle relative to the host vehicle;
evaluating the data signal; and
transmitting the alert signal to a driver in response to the evaluation of the data signal, wherein the alert signal represents the suitability of the potential parking space.

10. The method according to claim 9, wherein the measurement data includes a distance range and an angle between the host vehicle and other objects.

11. The method according to claim 9, wherein the sensor is an ultra wideband radar sensor with a predetermined resolution.

12. The method according to claim 9, wherein the sensor is disposed in a rear portion of the host vehicle.

13. The method according to claim 9, further comprising the step of providing a user interface in communication with the processor, wherein the user interface receives the alert signal and transmits a driver alert in response to the alert signal.

14. The method according to claim 9, wherein the processor includes at least one of a programmable component adapted to provide user-controlled management of at east one of the sensor and the processor and a storage device for storing information and data.

15. The method according to claim 9, wherein the evaluation of the measurement data includes at least one of calculating the dimensions of the potential parking space, applying a maneuverability factor to the calculated dimensions of the potential parking space, and determining a suitable position of the host vehicle for initiating a parallel parking maneuver.

16. A parallel park assist system for a host vehicle comprising:
a ultra wideband radar sensor disposed in the host vehicle, wherein the radar sensor obtains a measurement data relating to a potential parking space and transmits a data signal and transmits a data signal representing the measurement data;
a processor adapted to receive the transmitted data signal from the sensor, analyze the data signal, and transmit an alert signal in response to the analysis of the data signal; and
a user interface adapted to receive the alert signal and provide an alert to the driver of the host vehicle in response to the alert signal, wherein the alert signal represents the suitability of the potential parking space.

17. The parallel park assist system, according to claim 16, wherein the radar sensor has a predetermined resolution for measuring a distance rang and angle between the host vehicle and other objects.

18. The parallel park assist system according to claim 16, wherein the sensor is disposed in a rear portion of the host vehicle.

19. The parallel park assist system according to claim 16, wherein the processor includes at least one of a programmable component adapted to provide user-controlled management of at least one of the sensor and the processor and a storage device for storing information and data.

20. The parallel park assist system according to claim 16, wherein the analysis of the data signal includes at least one of calculating the dimensions of the potential parking space, applying a maneuverability factor to the calculated dimensions of the potential parking space, and determining a suitable position of the host vehicle for initiating a parallel parking maneuver.
